(19) United States
(12) Patent Application Publication
(10) Pub. No.: US 2009/0015176 A1
(43) Pub. Date: Jan. 15, 2009

(54) Laser assisted fluorescent lamp

(76) Inventor: Sitaramarao Srinivas Yechuri, Lake Forest, CA (US)

Correspondence Address: Sitaramarao Srinivas Yechuri, 203 Hamilton Ave, Apt 2D, Staten Island, NY, 10301, US

(21) Appl. No.: 11/827,070

(22) Filed: Jul. 11, 2007

(51) Int. Cl. H05B 41/36

(52) U.S. Cl. 315/291; 313/484

(57) ABSTRACT

In this invention a fluorescent lamp is described containing semiconductor laser diodes used to ionize the gases inside the lamp. This avoids the need for a high voltage to cause the gases to ionize sufficiently that current can flow through the lamp. If configured correctly, the use of Mercury vapor to initiate breakdown of the gases can be avoided. Also by regulating the light output of the laser the current flowing through the lamp can be regulated thus avoiding the need for a ballast.

### TECHNICAL FIELD OF THE INVENTION

This invention relates generally to the generation of light by a fluorescent lamp.

### BACKGROUND ART

Fluorescent lamps have been in existence for decades. However still flicker when they are turned on and require a high voltage to cause the gases inside the lamp to ionize and conduct an electric current. Mercury vapor is required to reduce the voltage at which ionization occurs and electrical current starts to flow. An electronic ballast is used to regulate the current flowing through the lamp.

This invention deals with an optical method of initiating and regulating the electrical current flowing through the lamp and the light emitted by the lamp.

### SUMMARY OF THE INVENTION

In this invention a fluorescent lamp is described containing semiconductor laser diodes used to ionize the gases inside the lamp. This avoids the need for a high voltage to cause the gases to ionize sufficiently that current can flow through the lamp. If configured correctly, the use of Mercury vapor to initiate breakdown of the gases can be avoided. Also by regulating the light output of the laser the current flowing through the lamp can be regulated thus avoiding the need for a ballast.

### DESCRIPTION OF INVENTION

The most comfortable source of light used in most homes and offices are the 4 foot fluorescent lamps. These lamps are long glass tubes coated on the inside with metallic and rare earth phosphor salts. The tubes are filled with Argon, Xenon, Neon and Mercury and then sealed. Electrodes at both ends provide both electrons via a hot cathode filament and also a voltage drop across the axis of the tube since the two ends alternate as anode and cathode. For the purposes of this patent application such lamps will be referred to as a “tubelight”.

This invention suggests the use of a laser diode such as a semiconductor laser diode, with a diffusing lens to supply photons of a slightly higher energy than required to ionize these gases Argon, Xenon or Neon. The laser diode is embedded at one or both ends of the tubelight. It is suggested that this method of ionization removes the requirement of a high voltage to fire the tubelight. It is suggested that the tubelight life is extended because of the removal of the high voltage when turning on the tubelight. It is suggested that this method of ionization will cause the tubelight to turn on gradually without the initial bright flash of light common in currently available tubelights thus making them more comfortable for humans. It is suggested that this method of ionization reduces the amount of Mercury required to fire the lamp and keep it turned on.

It is also suggested that this method of ionization will allow the development of long rectangular slab shaped fluorescent lamps with many laser diodes supplying light to illuminate and ionize the gases inside the lamp, thus allowing a ceiling lamp to be in the shape of a long flat panel of a low intensity radiation. It is suggested that such a long flat panel would allow the incorporation of a reflecting mirror on the top surface of the lamp so that light only emerges from the bottom of the lamp.

It is also suggested that this method of ionization will allow a reduction in the diameter of the tubelight, because the use of light to cause ionization can be adjusted so that the center of the length of the tubelight is ionized even for a tubelight of smaller diameter. In the case of conventional tubelights currently manufactured, if the diameter of the tube light is reduced, then so does the length of the lubelight have to be reduced because otherwise the center of the tubelight will not be ionized. Hence this method of ionization described in this patent application allows a geometry of the tubelight which could not be achieved with conventional tubelights.

It is also suggested that this method of ionization will allow avoiding the use of Mercury vapor to cause electrical breakdown of the gases in the lamp thus making this lamp more environmental friendly.

Finally, using this method it is possible to build a fluorescent lamp that is purely optically pumped, i.e. there is no current flowing through the lamp. All the ionization inside the lamp is caused by the absorption of the laser light by the gases inside the lamp. Here there is no negative resistance and there is no need for a ballast. Further there will be much less heat generated inside the lamp and it will run much cooler than conventional fluorescent lamps which also means that it will be more energy efficient.

What is claimed is:

1. A fluorescent lamp containing one or more lasers embedded in it such that the laser light output enters the fluorescent lamp.

2. The method of claim 1 wherein the lasers are semiconductor laser diodes.

3. The method of claim 1 wherein the lasers are used to ionize the gases inside the fluorescent lamp in order to cause electrical current to flow through the lamp.

4. The method of claim 3 wherein the laser's light output in decreased as the lamp current increases so as to regulate the current flowing through the lamp.

5. The method of claim 1 wherein an optical lens is used to spread and diffuse the light output of the lasers throughout the fluorescent lamp.

6. The method of claim 1 wherein the lamp enclosure is shaped in the form of a rectangular box.

7. The method of claim 6 wherein the lamp contains multiple electrodes to spread the flow of electrical current evenly across the rectangular lamp enclosure.

8. The method of claim 6 wherein one or more faces of the rectangular box is reflective so that light only emerges from the opposite face.

9. The method of claim 1 wherein the fluorescent lamp is purely optically pumped by the lasers i.e. no electricity flows through the lamp but only through the lasers.

10. The method of claim 1 wherein the fluorescent lamp contains reflective surfaces to reflect the laser light inside the lamp.

11. The method of claim 1 wherein the wavelength of the lasers are adjustable to adjust the pattern of light emitted by the fluorescent lamp.
